(19) United States
(12) Patent Application Publication
(10) Pub. No.: US 2021/0002477 A1
(43) Pub. Date: Jan. 7, 2021

(54) INORGANIC REINFORCED THERMOPLASTIC POLYESTER RESIN COMPOSITION

(71) Applicant: TOYOBO CO., LTD., Osaka (JP)

(72) Inventors: Takuya SHIMOHARAI, Shiga (JP); Motonobu KAMIYA, Shiga (JP); Takahiro SHIMIZU, Shiga (JP)

(73) Assignee: TOYOBO CO., LTD., Osaka (JP)

(21) Appl. No.: 16/977,653

(22) PCT Filed: Mar. 5, 2019
(86) PCT No.: PCT/JP2019/008508

§ 371 Date: Sep. 2, 2020

(30) Foreign Application Priority Data
Mar. 7, 2018 (JP) 2018-040707

(51) Int. Cl. C08L 67/02; C08J 5/04

(52) U.S. Cl. CPC C08L 67/02; C08J 5/043; C08J 2367/02; C08L 2205/025; C08J 2469/00; C08J 2433/08; C08L 2205/035; C08J 2467/03

(57) ABSTRACT

Disclosed is an inorganic reinforced thermoplastic polyester resin composition that does not lose the characteristics of a polyester resin, that maintains an excellent surface appearance while having high strength and high stiffness in a formulation containing an inorganic reinforcing material, such as glass fibers, and that undergoes less warping deformation and significantly less burr formation. The polyester resin composition comprises (A) 15 mass % or more and 30 mass % or less of a polybutylene terephthalate resin, (B) 1 mass % or more and less than 15 mass % of at least one polyester resin other than polybutylene terephthalate resins, (C) 5 mass % or more and 20 mass % or less of an amorphous resin, (D) 50 mass % or more and 70 mass % or less of an inorganic reinforcing material, (E) 0.1 mass % or more and 3 mass % or less of a glycidyl group-containing styrene copolymer, (F) 0.5 mass % or more and 2 mass % or less of an ethylene-glycidyl (meth)acrylate copolymer, and (G) 0.05 mass % or more and 2 mass % or less of a transesterification inhibitor.

### TECHNICAL FIELD

The present invention relates to an inorganic reinforced polyester resin composition comprising a thermoplastic polyester resin and an inorganic reinforcing material, such as glass fibers. More specifically, the present invention relates to an inorganic reinforced polyester resin composition that can form a thin, long molded article having excellent surface gloss with few appearance defects due to lifting etc. of the inorganic reinforcing material in the molded article while maintaining high stiffness and high strength, and having less warping deformation and extremely few burrs.

### BACKGROUND ART

In general, polyester resins have excellent mechanical properties, heat resistance, chemical resistance, and the like, and are widely used in automobile parts, electric and electronic parts, household sundries, etc. In particular, polyester resin compositions reinforced with inorganic reinforcing materials, such as glass fibers, have dramatically improved stiffness, strength, and heat resistance, and it is known that the stiffness thereof is particularly improved depending on the amount of inorganic reinforcing material added.

However, when a larger amount of inorganic reinforcing material, such as glass fibers, is added, the inorganic reinforcing material, such as glass fibers, may be lifted to the surface of molded articles, which significantly deteriorates the appearance, particularly surface gloss, and impairs the commercial value.

Therefore, as a method for improving the appearance of molded articles, it has been proposed to perform molding at an extremely high mold temperature, for example, 120° C. or higher, during molding. However, this method requires a special device to raise the mold temperature, and cannot be used for general molding using any molding machine. In addition, with this method, even when the mold temperature was raised to a high temperature, lifting of glass fibers etc. occurred at the end etc. of the molded article far away from the gate in the mold, thereby failing to obtain an excellent molding appearance, increasing warping of the molded article, and causing defects in some cases.

Further, in recent years, it has been proposed to modify molds so that molded articles with high gloss can be obtained using various inorganic reinforcing materials, such as glass fibers (PTL 1 and PTL 2). The purpose of this mold modification is that a highly insulating ceramic, such as zirconia ceramic, is inserted as a core into the cavity of a mold to control rapid cooling immediately after the cavity is filled with a molten resin, and the resin in the cavity is kept at a high temperature to obtain a molded article with excellent surface properties. However, these methods required expensive mold production. In addition, these methods were effective for molded articles of a simple shape, such as flat plates; however, in the case of complicated molded articles, there were problems that ceramic processing was difficult, and that it was difficult to produce molds with high precision.

Accordingly, there have been proposals for polyester resin compositions that do not require special modification of molds or high temperature setting, and that can ensure the appearance of molded articles and suppress warping deformation even in a resin formulation containing an inorganic reinforcing material, such as glass fibers, by improving the characteristics of the resin compositions (PTL 3 to PTL 6).

According to the compositions of the above literatures, when various amorphous resins, copolyesters, etc., are mixed and the crystallization behavior of the resin composition is controlled, an excellent surface appearance can be obtained and warping deformation can be suppressed in a resin composition containing glass fibers etc. even at a mold temperature of 100° C. or lower.

On the other hand, particularly when crystalline resins, such as polyester resins, are molded, burrs in the molded articles may become a problem, in addition to the above appearance and warping deformation. When burrs are formed, it requires a burr removal process etc., which requires time and cost. In particular, molded articles have recently tended to be thinner and smaller for the purpose of weight reduction, etc.; thus, the problem of burrs tends to be relatively large. Burr formation is caused by the mold factor due to gaps formed along with the aging of the molds; however, in general, the resin factor has a larger effect. It is known that when an amorphous resin is used, burrs tend to be reduced due to the viscosity characteristics thereof. However, for crystalline resins, there are few examples examining burrs, except for olefin resins that behave similarly to amorphous resins. Naturally, none of the prior art documents described so far refers to burrs. In the current situation, attempts to suppress burrs in terms of formulation have rarely been made in polyester resins. In general, when the flowability is too high, burrs tend to be formed; accordingly, it is easy to conceive of a method for increasing the resin viscosity. However, if the viscosity is simply increased, a very high pressure is required to fill the resin in the entire molded article; thus, the mold may open because it cannot withstand the pressure, resulting in burrs. This tendency becomes more remarkable in products with a thin thickness. A polyester resin composition solving this problem has already been proposed (PTL 7).

In recent years, the length of molded articles has been increasing, and there has been a demand for even higher stiffness (a flexural modulus exceeding 17 GPa). Therefore, the resin filling pressure tends to be higher, and many molded articles tend to have a shape in which burrs are easily formed. Even for thin, long molded articles, there has been a demand for materials that have an excellent appearance and suppress burr formation while achieving high stiffness and high strength. It has been a very important issue to balance these qualities.

### CITATION LIST

### Patent Literature

PTL 1: JP3421188B
PTL 2: JP3549341B
PTL 3: JP2008-214558A
PTL 4: JP3390539B
PTL 5: JP2008-120925A
PTL 6: JP4696476B
PTL 7: JP2013-159732A

### SUMMARY OF INVENTION

### Technical Problem

An object of the present invention is to provide a polyester resin composition that does not lose the characteristics of a polyester resin, that maintains an excellent surface appearance while having high strength and high stiffness (a flexural modulus exceeding 17 GPa) in a formulation containing an inorganic reinforcing material, such as glass fibers, that undergoes less warping deformation, and that produces a thin, long molded article with significantly less burr formation.

### Solution to Problem

According to the previous studies by the present inventors, it was found that when the mixing ratio of a polybutylene terephthalate resin, at least one polyester resin other than polybutylene terephthalate resins, and other components was adjusted in an inorganic reinforced thermoplastic polyester resin composition, excellent moldability and burr suppression could both be achieved particularly in the case of molding that required high cycle performance. However, when higher stiffness (a flexural modulus exceeding 17 GPa) was required for materials, and the molded articles had a thinner, longer shape, it was difficult for the materials of the previous inventions to maintain the effect of suppressing burrs. Therefore, it was essential to newly design a formulation in consideration of the stiffness of the materials and the shape of the molded articles.

As a result of further intensive studies, it was found that when the inorganic reinforced thermoplastic polyester resin composition contains an amorphous resin, and the mixing ratio of each component is readjusted, burrs can be effectively suppressed particularly in thin, long molded articles that require high stiffness. Thus, the present invention has been completed.

That is, the present invention has the following configuration.

[1]

An inorganic reinforced thermoplastic polyester resin composition, comprising:
(A) 15 mass % or more and 30 mass % or less of a polybutylene terephthalate resin,
(B) 1 mass % or more and less than 15 mass % of at least one polyester resin other than polybutylene terephthalate resins,
(C) 5 mass % or more and 20 mass % or less of an amorphous resin,
(D) 50 mass % or more and 70 mass % or less of an inorganic reinforcing material,
(E) 0.1 mass % or more and 3 mass % or less of a glycidyl group-containing styrene copolymer,
(F) 0.5 mass % or more and 2 mass % or less of an ethylene-glycidyl (meth)acrylate copolymer, and
(G) 0.05 mass % or more and 2 mass % or less of a transesterification inhibitor.

[2]

The inorganic reinforced thermoplastic polyester resin composition according to [1], wherein the at least one polyester resin other than polybutylene terephthalate resins (B) is a polyethylene terephthalate resin (B1) and/or a copolyester resin (B2).

[3]

The inorganic reinforced thermoplastic polyester resin composition according to [2], wherein the copolyester resin (B2) is a polyester resin comprising, as a copolymerization component, at least one member selected from the group consisting of terephthalic acid, isophthalic acid, sebacic acid, adipic acid, trimellitic acid, 2,6-naphthalenedicarboxylic acid, ethylene glycol, diethylene glycol, neopentyl glycol, 1,4-cyclohexanedimethanol, 1,4-butanediol, 1,2-propanediol, 1,3-propanediol, and 2-methyl-1,3-propanediol.

[4]

The inorganic reinforced thermoplastic polyester resin composition according to any one of [1] to [3], wherein the amorphous resin (C) is at least one member selected from the group consisting of polycarbonate resins and polyarylate resins.

[5]

The inorganic reinforced thermoplastic polyester resin composition according to any one of [1] to [4], wherein the glycidyl group-containing styrene copolymer (E) contains 2 or more glycidyl groups per molecule, has a weight average molecular weight of 1000 to 10000, and comprises 99 to 50 parts by mass of a styrene monomer, 1 to 30 parts by mass of a glycidyl (meth)acrylate, and 0 to 40 parts by mass of another acrylic monomer (an acrylic monomer different from said glycidyl (meth)acrylate).

[6]

The inorganic reinforced thermoplastic polyester resin composition according to any one of [1] to [5], wherein the inorganic reinforced thermoplastic polyester resin composition has a crystallization temperature during cooling of higher than 180° C., which is determined by a differential scanning calorimeter (DSC).

[7]

A molded article comprising the inorganic reinforced thermoplastic polyester resin composition according to any one of [1] to [6].

### Advantageous Effects of Invention

According to the present invention, even in a resin composition containing a large amount of inorganic reinforcing material, it is possible to suppress lifting of the inorganic reinforcing material on the surface of the molded article by adjusting the mixing ratio of each component; thus, the appearance of the molded article can be greatly improved, and it is possible to obtain a molded article with an excellent appearance and less warpage while having high strength and high stiffness. Furthermore, particularly in thin-walled, long molded articles, etc., it is possible to greatly suppress burr formation against the pressure during molding; thus, it is possible to eliminate a deburring process etc. after molding.

### DESCRIPTION OF EMBODIMENTS

The present invention is described in detail below. The mixing amount (content) of each component described below represents the amount (mass %) when the amount of the inorganic reinforced thermoplastic polyester resin composition is 100 mass %. Since the amount of each component mixed is the content in the inorganic reinforced thermoplastic polyester resin composition, the mixing amount and the content match with each other.

The polybutylene terephthalate resin (A) in the present invention is a main component with the highest content among all of the resin components constituting the inorganic reinforced thermoplastic polyester resin composition of the present invention. Although the polybutylene terephthalate resin (A) is not particularly limited, a homopolymer comprising terephthalic acid and 1,4-butanediol is mainly used. Further, other components can be copolymerized up to about 5 mol % within the range that does not impair moldability, crystallinity, surface gloss, and the like. Examples of other components include the components used in a copolyester resin (B2) described later.

As a scale of the molecular weight of the polybutylene terephthalate resin (A), the reduced viscosity (0.1 g of a sample is dissolved in 25 ml of a mixed solvent of phenol/tetrachloroethane (mass ratio: 6/4), and the viscosity is measured using an Ubbelohde viscosity tube at 30° C.; dl/g) is preferably in the range of 0.4 to 1.2 dl/g, and more preferably in the range of 0.5 to 0.8 dl/g. If the reduced viscosity is less than 0.4 dl/g, burrs are likely to occur due to the reduced toughness and overly high flowability of the resin. If the reduced viscosity exceeds 1.2 dl/g, burrs are also likely to occur due to the influence of significantly reduced flowability.

The amount of the polybutylene terephthalate resin (A) mixed is 15 to 30 mass %, preferably 16 to 29 mass %, and more preferably 17 to 28 mass %. When the polybutylene terephthalate resin is mixed within this range, various characteristics can be satisfied.

The at least one polyester resin other than polybutylene terephthalate resins (B) in the present invention is not particularly limited, but is preferably a polyethylene terephthalate resin (B1) and/or a copolyester resin (B2).

The polyethylene terephthalate resin (B1) is basically a homopolymer of ethylene terephthalate units. In addition, other components can be copolymerized up to about 5 mol % within the range that does not impair various characteristics. Examples of other components include the components used in the copolyester resin (B2) described below.

The copolyester resin (B2) is preferably a polyester resin comprising, as a copolymerization component, at least one member selected from the group consisting of terephthalic acid, isophthalic acid, sebacic acid, adipic acid, trimellitic acid, 2,6-naphthalenedicarboxylic acid, ethylene glycol, diethylene glycol, neopentyl glycol, 1,4-cyclohexanedimethanol, 1,4-butanediol, 1,2-propanediol, 1,3-propanediol, and 2-methyl-1,3-propanediol.

Among them, the copolyester resin (B2) is more preferably a copolyester comprising 40 mol % or more of terephthalic acid as a dicarboxylic acid component and 40 mol % or more of ethylene glycol as a glycol component. A copolyester comprising 50 mol or more of terephthalic acid as a dicarboxylic acid component and 50 mol % or more of ethylene glycol as a glycol component is more preferable. As the components to be copolymerized, examples of the acid component other than terephthalic acid include aromatic or aliphatic polybasic acids, such as isophthalic acid, naphthalene dicarboxylic acid, adipic acid, sebacic acid, and trimellitic acid, as well as esters thereof; and examples of the glycol component other than ethylene glycol include diethylene glycol, neopentyl glycol, 1,4-cyclohexanedimethanol, 1,4-butanediol, 1,2-propanediol, 1,3-propanediol, and 2-methyl-1,3-propanediol. The components to be copolymerized are preferably isophthalic acid and neopentyl glycol, from the viewpoint of easy availability and various characteristics. The amount of the copolymerization component is preferably more than 5 mol %, and more preferably 10 mol % or more, when the amount of the dicarboxylic acid component is 100 mol % and the amount of the glycol component is 100 mol %.

When the copolymerization component is neopentyl glycol, the copolymerization ratio thereof is preferably 20 to 60 mol %, and more preferably 25 to 50 mol %, when the amount of the glycol component is 100 mol %.

When the copolymerization component is isophthalic acid, the copolymerization ratio thereof is preferably 20 to 60 mol %, and more preferably 25 to 50 mol %, when the amount of the dicarboxylic acid component is 100 mol %.

As a scale of the molecular weight of the polyethylene terephthalate resin (B1), the reduced viscosity (0.1 g of a sample is dissolved in 25 ml of a mixed solvent of phenol/tetrachloroethane (mass ratio: 6/4), and the viscosity is measured at 30° C. using an Ubbelohde viscosity tube; dl/g) is preferably 0.4 to 1.0 dl/g, and more preferably 0.5 to 0.9 dl/g. If the reduced viscosity is less than 0.4 dl/g, the strength of the resin tends to decrease. If the reduced viscosity exceeds 1.0 dl/g, the flowability of the resin tends to decrease.

As a scale of the molecular weight of the copolyester resin (B2), the reduced viscosity is preferably 0.4 to 1.5 dl/g, and more preferably 0.4 to 1.3 dl/g, although it slightly varies depending on the specific copolymerization formulation. If the reduced viscosity is less than 0.4 dl/g, the toughness tends to decrease. If the reduced viscosity exceeds 1.5 dl/g, the flowability tends to decrease.

The amount of the at least one polyester resin other than polybutylene terephthalate resins (B) mixed is 1 mass % or more and less than 15 mass %, preferably 2 to 12 mass %, more preferably 3 to 10 mass %, and even more preferably 3 to 7 mass %. If the mixing amount is less than 1 mass %, appearance defects become noticeable due to lifting of glass fibers etc. If the mixing amount is 15 mass % or more, the molded article has an excellent appearance, but the molding cycle becomes longer, which is not preferable.

Further, from the viewpoint of satisfying both the appearance of the molded article and moldability, it is preferable that the polyester resin composition of the present invention comprises the component (B2).

The amorphous resin (C) in the present invention can be a resin that is generally known as an amorphous resin and that is different from the at least one polyester resin other than polybutylene terephthalate resins (B). Specifically, known resins, such as polycarbonate resins, polyarylate resins, polystyrene resins, and acrylonitrile-styrene copolymers, can be used. In consideration of the compatibility with the polyester resin and the burr-suppressing effect, polycarbonate resins and polyarylate resins are preferable.

The amount of the amorphous resin (C) mixed is 5 to 20 mass %, and preferably 6 to 18 mass %. If the amount of the amorphous resin (C) is less than 5 mass %, the burr-suppressing effect is low. If the amount of the amorphous resin (C) exceeds 20 mass %, the molding cycle is deteriorated due to the reduced crystallinity, and appearance defects are likely to occur due to the reduction of the flowability, which is not preferable.

The polycarbonate resin can be produced by a solvent method, that is, a reaction of a dihydric phenol with a carbonate precursor such as phosgene, or a transesterification reaction of a dihydric phenol with a carbonate precursor such as diphenyl carbonate, in the presence of a known acid acceptor and molecular weight modifier in a solvent such as methylene chloride. Dihydric phenols preferably used herein include bisphenols, and particularly 2,2-bis(4-hydroxyphenyl)propane, i.e., bisphenol A. Moreover, the bisphenol A may be partially or completely replaced with other dihydric phenols. Examples of dihydric phenols other than bisphenol A include compounds such as hydroquinone, 4,4-dihydroxydiphenyl, and bis(4-hydroxyphenyl)alkane; and halogenated bisphenols such as bis(3,5-dibromo-4-hydroxyphenyl)propane and bis(3,5-dichloro-4-hydroxyphenyl)propane. The polycarbonate may be a homopolymer using one dihydric phenol or a copolymer using two or more dihydric phenols, and may be a resin in which a component other than polycarbonate (e.g., a polyester component) is copolymerized within a range that does not impair the effects of the present invention (20 mass % or less).

The polycarbonate resin used herein is preferably one having a melt volume rate (unit: cm³/10 min), measured at 300° C. and a load of 1.2 kg, of 1 to 100, more preferably 2 to 80, and even more preferably 3 to 40. When a resin having a melt volume rate in this range is used, burrs can be effectively suppressed without impairing moldability. If a resin having a melt volume rate of less than 1 is used, flowability may be significantly reduced, and moldability may be deteriorated. If the melt volume rate exceeds 100, the molecular weight is too low, which leads to the deterioration of physical properties, and tends to cause problems such as gas generation due to decomposition.

The polyarylate resin used herein can be one produced by a known method. The polyarylate resin is preferably one having a melt volume rate (unit: cm³/10 min), measured at 360° C. and a load of 2.16 kg, of 1 to 100, more preferably 2 to 80, and even more preferably 3 to 40. When a resin having a melt volume rate in this range is used, burrs can be effectively suppressed without impairing moldability. If a resin having a melt volume rate of less than 1 is used, flowability may be significantly reduced, and moldability may be deteriorated. If the melt volume rate exceeds 100, the molecular weight is too low, which leads to the deterioration of physical properties, and tends to cause problems such as gas generation due to decomposition.

Examples of the inorganic reinforcing material (D) in the present invention include, but are not limited to, plate-crystal talc, mica, uncalcined clays, unspecified or spherical calcium carbonate, calcined clay, silica, glass beads, commonly used wollastonite and acicular wollastonite, glass fibers, carbon fibers, whiskers of aluminum borate or potassium titanate, milled fibers, which are short glass fibers having an average fiber diameter of about 4 to 20 μm and a cut length of about 35 to 150 μm, and the like. Talc and wollastonite are the most excellent in terms of the appearance of molded articles, and glass fibers are the most excellent in terms of strength and stiffness. These inorganic reinforcing materials may be used alone or in combination of two or more; however, it is preferable to mainly use glass fibers in terms of stiffness and the like.

As glass fibers among the inorganic reinforcing materials (D), chopped strand fibers cut into a fiber length of about 1 to 20 mm can be preferably used. Regarding the cross-sectional shape of glass fibers, glass fibers having a circular cross-section or a non-circular cross-section can be used. As glass fibers with a circular cross-section, general glass fibers having an average fiber diameter of about 4 to 20 μm and a cut length of about 3 to 6 mm can be used. Examples of glass fibers with a non-circular cross-section include those having an approximately elliptical, approximately oval, or approximately cocoon-like cross-section perpendicular to the fiber length direction, and in this case, the flatness is preferably 1.5 to 8. The flatness as mentioned herein is the ratio of major axis/minor axis where assuming a rectangle with a minimum area circumscribed with a cross-section of a glass fiber perpendicular to the longitudinal direction of the glass fiber, the length of the longer sides of the rectangle is defined as the major axis and the length of the shorter sides is defined as the minor axis. Although the thickness the glass fibers is not particularly limited, those having a minor axis diameter of about 1 to 20 μm and a major axis diameter of about 2 to 100 μm can be used.

As these glass fibers, those that have been previously treated with a conventionally known coupling agent, such as an organic silane compound, an organic titanium compound, an organic borane compound, or an epoxy compound, can be preferably used.

The amount of the inorganic reinforcing material (D) mixed in the present invention is 50 to 70 mass %, preferably 53 to 67 mass %, and more preferably 55 to 65 mass %. When the inorganic reinforcing material is mixed within this range, various characteristics can be satisfied.

When talc is used as the inorganic reinforcing material (D), it is important to use it within the range of 1 mass % or less in the resin composition, even when used in combination as the component (D). Since talc acts as a crystal nucleating agent, if it is used in excess of this amount, the crystallization rate increases, and appearance defects, such as glass lifting, tend to occur, which is not preferable.

Since the inorganic reinforced thermoplastic polyester resin composition of the present invention contains 50 to 70 mass % of the inorganic reinforcing material (D), the flexural modulus of a molded article obtained by injection molding of the inorganic reinforced thermoplastic polyester resin composition can exceed 17 GPa.

The glycidyl group-containing styrene copolymer (E) used in the present invention is obtained by polymerizing a monomer mixture containing a glycidyl group-containing acrylic monomer and a styrene monomer, or obtained by polymerizing a monomer mixture containing a glycidyl group-containing acrylic monomer, a styrene monomer, and another acrylic monomer (an acrylic monomer different from said glycidyl group-containing acrylic monomer).

Examples of the glycidyl group-containing acrylic monomer include glycidyl (meth)acrylate, (meth)acrylic acid ester having a cyclohexene oxide structure, (meth)acrylic glycidyl ether, and the like. The glycidyl group-containing acrylic monomer is preferably highly reactive glycidyl (meth)acrylate.

As the styrene monomer, styrene, α-methylstyrene, and the like, are used.

Examples of another acrylic monomer include (meth)acrylic acid alkyl esters having a C₁₋₂₂ alkyl group (the alkyl group may be linear or branched), such as methyl (meth)acrylate, ethyl (meth)acrylate, propyl (meth)acrylate, butyl (meth)acrylate, 2-ethylhexyl (meth)acrylate, cyclohexyl (meth)acrylate, stearyl (meth)acrylate, and methoxyethyl (meth)acrylate; (meth)acrylic acid polyalkylene glycol esters, (meth)acrylic acid alkoxyalkyl esters, (meth)acrylic acid hydroxyalkyl esters, (meth)acrylic acid dialkylaminoalkyl esters, (meth)acrylic acid benzyl esters, (meth)acrylic acid phenoxyalkyl esters, (meth)acrylic acid isobornyl esters, (meth)acrylic acid alkoxysilylalkyl esters, and the like. (Meth)acrylamide and (meth)acryldialkylamide can also be used. These can be used alone or in combination of two or more.

The glycidyl group-containing styrene copolymer (E) in the present invention is preferably a copolymer comprising 99 to 50 parts by mass of a styrene monomer, 1 to 30 parts by mass of glycidyl (meth)acrylate, and 0 to 40 parts by mass of another acrylic monomer (an acrylic monomer different from glycidyl (meth)acrylate), when the amount of the glycidyl group-containing styrene copolymer is 100 parts by mass. The ratio of each monomer is sequentially more preferably 95 to 50 parts by mass, 5 to 20 parts by mass, and 0 to 40 parts by mass; and even more preferably 93 to 60 parts by mass, 7 to 15 parts by mass, and 0 to 30 parts by mass.

If the content of the styrene monomer is less than 50 parts by mass, the miscibility with the polyester resin is poor, and gelation tends to occur easily, which may reduce the stiffness of the composition. Further, if the content of glycidyl (meth)acrylate exceeds 30 parts by mass, gelation tends to occur easily.

Specific examples of the glycidyl group-containing styrene copolymer (E) include, but are not limited to, a styrene/glycidyl (meth)acrylate copolymer, a styrene/glycidyl (meth)acrylate/methyl (meth)acrylate copolymer, a styrene/glycidyl (meth)acrylate/butyl (meth)acrylate copolymer, and the like.

The glycidyl group-containing styrene copolymer (E) used in the present invention preferably contains an average of 2 to 5 glycidyl groups per molecular chain. If the number of glycidyl groups per molecular chain is less than 2, thickening is insufficient. If the number of glycidyl groups per molecular chain exceeds 5, gelation etc. of the composition is likely to occur, and the retention stability of the composition is degraded.

When the concentration of glycidyl groups is represented by an epoxy value, it is preferably 300 to 1800 eq/10⁶ g, more preferably 400 to 1700 eq/10⁶ g, and even more preferably 500 to 1600 eq/10⁶ g.

If the epoxy value is less than 300 eq/10⁶ g, the reactivity with the polyester resin may be insufficient, and the thickening effect may be insufficient. On the other hand, if the epoxy value exceeds 1800 eq/10⁶ g, gelation etc. occurs, which may adversely affect the appearance of the molded article and moldability.

The weight average molecular weight of the glycidyl group-containing styrene copolymer (E) is preferably 1000 to 10000, more preferably 3000 to 10000, and even more preferably 5000 to 10000. If the weight average molecular weight is less than 1000, the unreacted glycidyl group-containing styrene copolymer may bleed out to the surface of the molded article and cause contamination of the surface of the molded article. On the other hand, if the weight average molecular weight exceeds 10000, the compatibility with the polyester resin becomes poor, and phase separation, gelation, etc., occur, which may adversely affect the appearance of the molded article.

The amount of the glycidyl group-containing styrene copolymer (E) mixed is 0.1 to 3 mass %, preferably 0.3 to 2.5 mass %, and more preferably 0.5 to 2.2 mass %. The optimal mixing amount varies depending on the epoxy value. If the epoxy value is high, the amount of addition may be small, and if the epoxy value is low, the amount of addition should be large. Within the above range of the epoxy value, if the mixing amount is less than 0.1 mass %, the thickening effect is low, and if the mixing amount exceeds 3 mass %, the viscosity of the resin composition increases and the flowability decreases, which may adversely affect the appearance of the molded article and moldability.

As the ethylene-glycidyl (meth)acrylate copolymer (F) used in the present invention, a copolymer having 3 to 12 mass % of a glycidyl (meth)acrylate component in the entire copolymer can be preferably used. A copolymer having 3 to 6 mass % of a glycidyl (meth)acrylate component is more preferable.

As the ethylene-glycidyl (meth)acrylate copolymer (F), a terpolymer in which vinyl acetate, acrylic ester, or the like is further copolymerized, in addition to ethylene and glycidyl (meth)acrylate, can also be used.

The amount of the ethylene-glycidyl (meth)acrylate copolymer (F) mixed is 0.5 to 2 mass %. For burrs, the addition of a larger amount of the component (F) improves the viscosity of the entire resin composition and suppresses burr formation in the pressure-holding process. Conversely, however, considerable pressure is applied to thin-walled molded articles. As a result, the mold is likely to open, causing burrs, and the flowability is significantly reduced, which increases the possibility that the appearance of the molded article will be deteriorated. The mixing amount is preferably 0.7 to 1.8 mass %, and more preferably 0.8 to 1.7 mass %.

In particular, in order for thin, long molded articles, which require high stiffness (a flexural modulus exceeding 17 GPa), to extremely suppress burrs while maintaining an excellent appearance, it is preferable, in addition to adding the component (C), to adjust the mass ratio of the component (A) and the component (B) (i.e., (A)/(B)) to more than 1.6, and to adjust the mass ratio of the component (B) and the component (F) (i.e., (B)/(F)) to 10 or less. When (A)/(B) is 1.6 or less, or (B)/(F) is more than 10, the burr-suppressing effect is insufficient. The mass ratio (A)/(B) of the components (A) and (B) is more preferably 2.0 or more, and even more preferably 3.0 or more. The mass ratio (B)/(F) of the components (B) and (F) is more preferably 8 or less, and even more preferably 7 or less. The lower limit of (B)/(F) is preferably 2, and more preferably 3.

The transesterification inhibitor (G) used in the present invention is a stabilizer that prevents the transesterification reaction of polyester resins etc. With alloys of polyester resins, the transesterification reaction occurs to some extent due to the addition of heat history, no matter how much the production conditions are optimized. If the degree of the reaction becomes extremely large, characteristics expected from the alloy cannot be obtained. In particular, since the transesterification reaction of a polybutylene terephthalate resin and a polycarbonate resin often occurs, simply alloying them would significantly reduce the crystallinity of polybutylene terephthalate, which is not preferable. In the present invention, the transesterification reaction between the polybutylene terephthalate resin (A) and the amorphous resin (C) (polycarbonate resin, polyarylate resin, etc.) is particularly prevented by adding the component (G), whereby more appropriate crystallinity can be maintained.

As the transesterification inhibitor (G), a phosphorus compound having a catalyst deactivation effect on polyester resins can be preferably used. For example, “Adekastab AX-71” produced by ADEKA Co., Ltd. can be used.

The amount of the transesterification inhibitor (G) mixed is 0.05 to 2 mass %, and more preferably 0.1 to 1 mass %. If the amount of the transesterification inhibitor (G) is less than 0.05 mass %, the desired transesterification reaction prevention performance is not exhibited in many cases, and the deterioration of the crystallinity of the inorganic reinforced thermoplastic polyester resin composition may reduce the mechanical properties and cause mold release defects during injection molding. On the contrary, even if the addition amount exceeds 2 mass %, the effect is not enhanced so much; rather, it may cause the increase of gas and the like.

According to the inorganic reinforced thermoplastic polyester resin composition of the present invention, in the molding of a long molded article (150×20×3 mm (thickness)) at a cylinder temperature of 295° C. and a mold temperature of 110° C., it is possible to set the maximum amount of burr formation at the flow end to less than 0.20 mm when a holding pressure of 75 MPa is applied for a filling time of 0.5 seconds. Burrs are generally most likely to occur because the resin squeezes out of the mold due to the pressure in the pressure-holding process. This can be improved by adjusting the holding pressure; however, in that case, other defects (e.g., sink marks and appearance defects) may occur. In terms of resin, an improvement can be achieved by adjusting the resin viscosity so that it can withstand the pressure applied during pressure holding. However, although the method of increasing the viscosity of the entire resin is effective for burrs in the pressure-holding process, a large amount of pressure is required to fill the resin; as a result, the mold opens during injection, causing burrs. This tendency is especially remarkable in thin-walled molded articles.

Therefore, the resin ideal for obtaining excellent thin-walled molded articles without burrs has a melt viscosity behavior with good flowability during injection (during high shear) and increased resin viscosity in the pressure-holding process (during low shear). Resins exhibiting such behavior include olefin resins such as polyethylene, and amorphous resins such as acrylic resins. Therefore, it is easy to conceive of adding these resins to the polyester resin.

However, when an olefin resin or an acrylic resin is simply added, a relatively large amount of addition is required to achieve the ideal behavior; thus, the characteristics of the resin composition change, and the viscosity of the entire system increases, as described above. However, it was surprisingly found that the ideal melt viscosity behavior can be achieved without deteriorating the characteristics of the resin composition by adding prescribed small amounts of a glycidyl group-containing styrene copolymer and an ethylene-glycidyl (meth)acrylate copolymer, further mixing an amorphous resin, and adjusting the mixing amount of a polyester resin; and that burr formation can be suppressed. These findings are the points of the present invention.

In the inorganic reinforced thermoplastic polyester resin composition of the present invention, the crystallization temperature during cooling, which is determined by a differential scanning calorimeter (DSC), is preferably higher than 180° C. The crystallization temperature during cooling is the crystallization peak top temperature of a thermogram obtained using a differential scanning calorimeter (DSC) by raising the temperature to 300° C. at a heating rate of 20° C./min in a nitrogen flow, holding that temperature for 5 minutes, and then lowering the temperature to 100° C. at a rate of 10° C./min. If the crystallization temperature during cooling is 180° C. or less, the low crystallization speed may case mold release defects due to sticking to the mold, and may lead to deformation during ejection. The crystallization temperature during cooling is preferably 195° C. or lower, and more preferably 193° C. or lower.

In particular, in a formulation containing a large amount of inorganic reinforcing material, when the crystallization temperature during cooling is higher than 180° C., the inorganic reinforcing material, such as glass fibers, generally tends to stand out on the surface of the molded article (so-called glass lifting). The cause thereof is that because the crystallization speed of the polyester resin composition increases, the propagation speed of the injection pressure tends to decrease, and the inorganic reinforcing material, such as glass fibers, is partially exposed to the surface of the molded article. However, in the inorganic reinforced thermoplastic polyester resin composition of the present invention, the mixing amount of each component is adjusted so that an excellent appearance can be obtained even at a temperature of higher than 180° C., and it is possible to achieve both excellent moldability and an excellent appearance.

In addition, the inorganic reinforced thermoplastic polyester resin composition of the present invention may contain various known additives, as required, within the range that does not impair the characteristics of the present invention. Examples of known additives include colorants such as pigments, release agents, heat resistance stabilizers, antioxidants, UV absorbers, light stabilizers, plasticizers, modifiers, antistatic agents, flame retardants, dyes, and the like. These various additives can be contained in a total amount up to 5 mass % when the amount of the inorganic reinforced thermoplastic polyester resin composition is 100 mass %. That is, the total amount of (A), (B), (C), (D), (E), (F), and (G) is preferably 95 to 100 mass %, based on 100 mass % of the inorganic reinforced thermoplastic polyester resin composition.

Examples of release agents include long-chain fatty acids or esters thereof, metal salts, amide compounds, polyethylene wax, silicone, polyethylene oxide, and the like. The long-chain fatty acid preferably has 12 or more carbon atoms, and examples thereof include stearic acid, 12-hydroxystearic acid, behenic acid, montanic acid, and the like. Carboxylic acid may be partially or completely esterified with monoglycol or polyglycol, or a metal salt may be formed. Examples of amide compounds include ethylene bisterephthalamide, methylene bisstearylamide, and the like. These release agents may be used alone or as a mixture.

As a method for producing the inorganic reinforced thermoplastic polyester resin composition of the present invention, it can be produced by mixing the above-mentioned components and optionally various stabilizers, pigments, etc., and melt-kneading them. The melt-kneading method may be any method known to those skilled in the art. Usable examples include a single-screw extruder, a twin-screw extruder, a pressure kneader, a Banbury mixer, and the like. Among these, a twin-screw extruder is preferably used. As general melt-kneading conditions, for a twin-screw extruder, the cylinder temperature is 230 to 300° C. and the kneading time is 2 to 15 minutes.

### EXAMPLES

The present invention is described in more detail below with reference to Examples; however, the present invention is not limited to these Examples. The measured values described in the Examples are measured by the following methods.

### (1) Reduced Viscosity of Polyester Resin

0.1 g of a sample was dissolved in 25 ml of a mixed solvent of phenol/tetrachloroethane (mass ratio: 6/4), and the viscosity was measured at 30° C. using an Ubbelohde viscosity tube (unit: dl/g).

### (2) Amount of Burr Formation

As for the amount of burr formation, when a long molded article (150 mm×20 mm×3 m (thickness)) was molded by injection molding at a cylinder temperature of 295° C. and a mold temperature of 110° C., the maximum length (height) of burr at the flow end generated in the molded article when a holding pressure of 75 MPa was applied at an injection speed in which the filling time was 0.5 seconds was measured using a microscope.

### (3) Appearance of Molded Article (Lifting of Glass Fibers Etc.)

The appearance of the molded articles molded under the above conditions (2) was visually observed. “A” means a level without any problems.
A: The appearance was excellent without appearance defects due to lifting of glass fibers etc. on the surface.
B: The molded article had a few appearance defects particularly at its end etc.
C: The entire molded article had appearance defects.

### (4) Appearance of Molded Article (Emboss Ununiformity)

The appearance of the molded articles molded under the above conditions (2) was visually observed. For emboss, a mold with a pearskin embossing finished surface (15 μm in depth) was used. “A” and “B” mean a level without any problems.
A: The appearance was excellent without appearance defects due to displaced embossing on the surface.
B: A few parts of the molded article had appearance defects due to displaced embossing, and looked white when observed at different angles.
C: The entire molded article had appearance defects due to displaced embossing, and looked white when observed at different angles.

### (5) Moldability

When molding was carried out under the above conditions (2), moldability was determined based on releasability when the cooling time after the completion of the injection process was set to 12 seconds.
A: There were no problems in mold release, and continuous molding was easily possible.
C: Molding failure occurred once every shot or every few shots, and continuous molding was impossible due to a remainder of sprue on the fixing side of the mold etc.

The raw materials used in the Examples and Comparative Examples are as follows:

### (A) Polybutylene Terephthalate Resin

Polybutylene terephthalate: produced by Toyobo Co., Ltd., reduced viscosity: 0.65 dl/g

### (B1) Polyethylene Terephthalate Resin

Polyethylene terephthalate: produced by Toyobo Co., Ltd., reduced viscosity: 0.65 dl/g

### (B2) Copolyester Resin

The production method is described later.
Co-PET1: a copolymer having a compositional ratio of TPA//EG/NPG=100//70/30 (mol %), reduced viscosity: 0.83 dl/g
Co-PET2: a copolymer having a compositional ratio of TPA/IPA//EG/NPG=50/50//50/50 (mol %), reduced viscosity: 0.56 dl/g

### (C) Amorphous Resin

(C-1) Polycarbonate resin: “Calibre 301-6,” produced by Sumika Styron Polycarbonate Limited, melt volume rate (300° C., load: 1.2 kg): 6 cm³/10 min
(C-2) Polycarbonate resin: “Calibre 200-80,” produced by Sumika Styron Polycarbonate Limited, melt volume rate (300° C., load: 1.2 kg): 80 cm³/10 min
(C-3) Polyarylate resin: “U-Polymer,” produced by Unitika Ltd., melt volume rate (360° C., load: 2.16 kg): 4.0 cm³/10 min

### (D) Inorganic Reinforcing Material

Glass fiber: “T-120H,” produced by Nippon Electric Glass Co., Ltd.

### (E) Glycidyl Group-Containing Styrene Copolymer

(E-1) and (E-2) were used. Their production methods are described late.

### (F) Ethylene-Glycidyl (Meth)Acrylate Copolymer

Ethylene-glycidyl methacrylate-methyl acrylate terpolymer (glycidyl methacrylate component: 6 mass %), “Bond First 7M,” produced by Sumitomo Chemical Co., Ltd.

### (G) Transesterification Inhibitor

“Adekastab AX-71,” produced by ADEKA Co., Ltd.

### Additives

Stabilizer: “Irganox 1010,” produced by Chiba Japan
Release agent: “Licolub WE40,” produced by Clariant Japan
Black pigment: “PAB-8K470,” produced by Sumika Color Co., Ltd.

### Copolyester Resin (B2): Polymerization Example of Co-PET1

In a 10-L esterification reaction tank equipped with a stirrer and a distillation condenser, 2414 parts by mass of terephthalic acid (TPA), 1497 parts by mass of ethylene glycol (EG), and 515 parts by mass of neopentyl glycol (NPG) were placed. As catalysts, an 8 g/L aqueous solution of germanium dioxide was added so that the resulting polymer contained 30 ppm of germanium atoms, and a 50 g/L ethylene glycol solution of cobalt acetate tetrahydrate was added so that the resulting polymer contained 35 ppm of cobalt atoms. Then, the temperature inside the reaction system was gradually raised to 240° C., and the esterification reaction was carried out at a pressure of 0.25 MPa for 180 minutes. After it was confirmed that no distilled water was released from the reaction system, the reaction system was returned to normal pressure, and a 130 g/L ethylene glycol solution of trimethyl phosphate was added so that the resulting polymer contained 53 ppm of phosphorus atoms. The obtained oligomer was transferred to a polycondensation reaction tank, and the pressure was reduced while gradually increasing the temperature so that finally the temperature reached 280° C. and the pressure reached 0.2 MPa. The reaction was continued until the torque value of the stirring blade with respect to the intrinsic viscosity reached a desired value, and the polycondensation reaction was terminated. The reaction time was 100 minutes. The resulting molten polyester resin was discharged in the form of strands from the discharge port at the bottom of the polymerization tank, cooled in a water tank, then cut into chips, and recovered. As a result of the NMR analysis of the copolyester resin thus obtained, the dicarboxylic acid component had a formulation of 100 mol % of terephthalic acid, and the diol component had a formulation of 70 mol % of ethylene glycol and 30 mol % of neopentyl glycol.

### Copolyester Resin (B2): Polymerization Example of Co-PET2

Co-PET2 was produced in the same manner as in the polymerization example of Co-PET1, except for the raw materials and composition ratios used. IPA refers to isophthalic acid.

### Production Example of Glycidyl Group-Containing Styrene Copolymer (E-1)

The oil jacket temperature of a 1-L pressure stirred tank reactor equipped with an oil jacket was maintained at 200° C. On the other hand, a monomer mixture comprising 74 parts by mass of styrene (St), 20 parts by mass of glycidyl methacrylate (GMA), 6 parts by mass of butyl acrylate, 15 parts by mass of xylene, and 0.5 parts by mass of ditertiary butyl peroxide (DTBP) as a polymerization initiator was placed in a raw material tank. The monomer mixture was continuously fed from the raw material tank to the reactor at a constant feed rate (48 g/min, residence time: 12 minutes), and the reaction liquid was continuously extracted from the outlet of the reactor so that the content liquid mass of the reactor was constant at about 580 g. The temperature inside the reactor at that time was maintained at about 210° C. After 36 minutes had passed since the temperature inside the reactor became stable, the extracted reaction liquid was continuously treated to remove volatile components with a thin-film evaporator kept at a decompression degree of 30 kPa and a temperature of 250° C., thereby recovering a polymer (E-1) containing almost no volatile components.

The obtained polymer (E-1) had a weight average molecular weight of 9700 and a number average molecular weight of 3300 according to GPC analysis (polystyrene conversion value). The epoxy value was 1400 eq/10 g, and the epoxy valence (the average number of epoxy groups per molecule) was 3.8.

### Production Example of (E-2)

A polymer (E-2) was produced in the same manner as in the production of the polymer (E-1), except for using a monomer mixture comprising 89 parts by mass of St, 11 parts by mass of GMA, 15 parts by mass of xylene, and 0.5 parts by mass of DTBP.

The obtained polymer had a mass average molecular weight of 8500 and a number average molecular weight of 3300 according to GPC analysis (polystyrene conversion value). The epoxy value was 670 eq/10⁶ g, and the epoxy valence (the average number of epoxy groups per molecule) was 2.2.

Regarding the inorganic reinforced thermoplastic polyester resin compositions of the Examples and the Comparative Examples, the above raw materials were weighed in accordance with the mixing ratio (mass %) shown in Table 1, and melt-kneaded by a 35-diameter twin-screw extruder (produced by Toshiba Machine Co., Ltd.) at a cylinder temperature of 270° C. at a screw rotation speed of 100 rpm. The raw materials other than glass fibers were fed into the twin-screw extruder from a hopper, and the glass fibers were fed by side-feeding from a vent port. The obtained pellets of each inorganic reinforced thermoplastic polyester resin composition were dried and then molded into various evaluation samples with an injection-molding machine. The molding conditions were a cylinder temperature of 295° C. and a mold temperature of 110° C. Table 1 shows the evaluations results.

TABLE 1

| | | Example | | | | | | | | | |
|---|---|---|---|---|---|---|---|---|---|---|---|
| | | 1 | 2 | 3 | 4 | 5 | 6 | 7 | 8 | 9 | 10 |
| Formulation | (A) Polybutylene terephthalate | 21 | 21 | 21 | 29 | 21 | 21 | 16 | 22 | 21 | 20.5 |
| | (B1) Polyethylene terephthalate | 5 | | | | | | | | | |
| | (B2) Co-PET1 | | 5 | | 5 | 5 | 5 | 4 | 5.5 | 5 | 5 |
| | (B2) Co-PET2 | | | 5 | | | | | | | |
| | (C-1) Polycarbonate resin | 16 | 16 | 16 | 8 | | | 12 | 16 | 16 | 16 |
| | (C-2) Polycarbonate resin | | | | | 16 | | | | | |
| | (C-3) Polyarylate resin | | | | | | 16 | | | | |
| | (D) Glass fibers | 53.1 | 53.1 | 53.1 | 53.1 | 53.1 | 53.1 | 63.1 | 53.1 | 53.1 | 53.1 |
| | (E-1) | 2 | 2 | 2 | 2 | 2 | 2 | 2 | 0.5 | | 2 |
| | (E-2) | | | | | | | | | 2 | |
| | (F) | 1 | 1 | 1 | 1 | 1 | 1 | 1 | 1 | 1 | 1.5 |
| | (G) | 0.2 | 0.2 | 0.2 | 02 | 0.2 | 0.2 | 0.2 | 0.2 | 0.2 | 0.2 |
| Ratio | A/B | 4.2 | 4.2 | 4.2 | 5.8 | 4.2 | 4.2 | 4.0 | 4.0 | 4.2 | 4.1 |
| | B/F | 5 | 5 | 5 | 5 | 5 | 5 | 4 | 6 | 5 | 3 |
| Characteristics | Amount of burr [mm] | 0.09 | 0.04 | 0.05 | 0.12 | 0.07 | 0.04 | 0.04 | 0.16 | 0.05 | 0.03 |
| | Appearance of molded article | A | A | A | A | A | A | A | A | A | A |
| | (lifting of glass fibers etc.) | | | | | | | | | | |
| | Appearance of molded article | B | A | A | A | A | A | A | A | A | A |
| | (emboss ununiformity) | | | | | | | | | | |
| | Moldability | A | A | A | A | A | A | A | A | A | A |
| | Crystallization temperature | 190 | 189 | 189 | 191 | 189 | 183 | 189 | 189 | 189 | 188 |
| | during cooling [° C.] | | | | | | | | | | |

Comparative Example

| | | | | | | |
|---|---|---|---|---|---|---|
| 1 | 2 | 3 | 4 | 5 | 6 | 7 |

| | | | | | | | | |
|---|---|---|---|---|---|---|---|---|
| Formulation | (A) Polybutylene terephthalate | 27 | 22 | 22 | 21 | 21 | 26 | 34 |
| | (B1) Polyethylene terephthalate | 5 | | | | | | |
| | (B2) Co-PET1 | 11 | 5.5 | 5 | 5 | | | |
| | (B2) Co-PET2 | | | | | | | |
| | (C-1) Polycarbonate resin | | 16 | 16 | 16 | 21 | 16 | 8 |
| | (C-2) Polycarbonate resin | | | | | | | |
| | (C-3) Polyarylate resin | | | | | | | |
| | (D) Glass fibers | 53.0 | 53.6 | 53.1 | 53.3 | 53.1 | 53.1 | 53.1 |
| | (E-1) | 0.3 | | 2 | 2 | 2 | 2 | 2 |
| | (E-2) | | | | | | | |
| | (F) | 2 | 1 | | 1 | 1 | 1 | 1 |
| | (G) | | 0.2 | 0.2 | | 0.2 | 0.2 | 0.2 |
| Ratio | A/B | 1,7 | 4.0 | 4.4 | 4.2 | — | — | — |
| | B/F | 8 | 6 | — | 5 | 0 | 0 | 0 |
| Characteristics | Amount of burr [mm] | 0.29 | 0.19 | 0.20 | 0.02 | 0.04 | 0.10 | 0.15 |
| | Appearance of molded article | A | A | A | A | A | B | C |
| | (lifting of glass fibers etc.) | | | | | | | |
| | Appearance of molded article | A | A | A | A | A | B | C |
| | (emboss ununiformity) | | | | | | | |
| | Moldability | A | A | A | C | C | A | A |
| | Crystallization temperature | 175 | 189 | 190 | 169 | 177 | 191 | 193 |
| | during cooling [° C.] | | | | | | | |

(Note)
*The formulation is expressed by mass ratio (100 mass % of the entire resin composition).
*Each formulation contains 0.2 mass % of stabilizer (antioxidant), 0.5 mass % of release agent, and 1 mass % of black pigment.

As is clear from Table 1, in Examples 1 to 10, which satisfy the ranges specified in the present invention, the amount of burr formation can be significantly suppressed while maintaining the appearance of the molded articles and moldability.

On the other hand, in Comparative Examples 1 to 3, which do not contain the predetermined components, the effect of suppressing burrs is low. In Comparative Example 4, which did not contain (G), the transesterification reaction proceeded remarkably, and the crystallinity was reduced, so that the moldability (releasability) was deteriorated. In Comparative Example 5, which contained (C) in an amount exceeding the predetermined range, the moldability (releasability) was deteriorated. Further, in Comparative Examples 6 and 7, which did not contain (B), appearance defects were observed due to lifting of the inorganic reinforcing material and emboss ununiformity.

### INDUSTRIAL APPLICABILITY

According to the present invention, even in a resin composition containing a large amount of inorganic reinforcing material, it is possible to suppress lifting of the inorganic reinforcing material on the surface of the molded article by adjusting the mixing ratio of each component; thus, the appearance of the molded article can be greatly improved, and it is possible to obtain a molded article with an excellent appearance and less warpage while having high strength and high stiffness. Furthermore, particularly in thin-walled, long molded articles, etc., it is possible to greatly suppress burr formation against the pressure during molding; thus, it is possible to eliminate a deburring process etc. after molding. Therefore, the present invention significantly contributes to the industrial world.

1. An inorganic reinforced thermoplastic polyester resin composition, comprising:
(A) 15 mass % or more and 30 mass % or less of a polybutylene terephthalate resin,
(B) 1 mass % or more and less than 15 mass % of at least one polyester resin other than polybutylene terephthalate resins,
(C) 5 mass % or more and 20 mass % or less of an amorphous resin,
(D) 50 mass % or more and 70 mass % or less of an inorganic reinforcing material,
(E) 0.1 mass % or more and 3 mass % or less of a glycidyl group-containing styrene copolymer,
(F) 0.5 mass % or more and 2 mass % or less of an ethylene-glycidyl (meth)acrylate copolymer, and
(G) 0.05 mass % or more and 2 mass % or less of a transesterification inhibitor.

2. The inorganic reinforced thermoplastic polyester resin composition according to claim 1, wherein the at least one polyester resin other than polybutylene terephthalate resins (B) is a polyethylene terephthalate resin (B1) and/or a copolyester resin (B2).

3. The inorganic reinforced thermoplastic polyester resin composition according to claim 2, wherein the copolyester resin (B2) is a polyester resin comprising, as a copolymerization component, at least one member selected from the group consisting of terephthalic acid, isophthalic acid, sebacic acid, adipic acid, trimellitic acid, 2,6-naphthalenedicarboxylic acid, ethylene glycol, diethylene glycol, neopentyl glycol, 1,4-cyclohexanedimethanol, 1,4-butanediol, 1,2-propanediol, 1,3-propanediol, and 2-methyl-1,3-propanediol.

4. The inorganic reinforced thermoplastic polyester resin composition according to claim 1, wherein the amorphous resin (C) is at least one member selected from the group consisting of polycarbonate resins and polyarylate resins.

5. The inorganic reinforced thermoplastic polyester resin composition according to claim 1, wherein the glycidyl group-containing styrene copolymer (E) contains 2 or more glycidyl groups per molecule, has a weight average molecular weight of 1000 to 10000, and comprises 99 to 50 parts by mass of a styrene monomer, 1 to 30 parts by mass of a glycidyl (meth)acrylate, and 0 to 40 parts by mass of another acrylic monomer.

6. The inorganic reinforced thermoplastic polyester resin composition according to claim 1, wherein the inorganic reinforced thermoplastic polyester resin composition has a crystallization temperature during cooling of higher than 180° C., which is determined by a differential scanning calorimeter (DSC).

7. A molded article comprising the inorganic reinforced thermoplastic polyester resin composition according to claim 1.
